(19) United States
(12) Patent Application Publication
(10) Pub. No.: US 2021/0086435 A1
(43) Pub. Date: Mar. 25, 2021

(54) HEATING MODULE, METHOD FOR PRODUCING A MOLDED PART AND DEVICE FOR PRODUCING A MOLDED PART

(71) Applicant: LEONHARD KURZ Stiftung & Co. KG, Fürth (DE)

(72) Inventors: Oliver Leyh, Fürth (DE); Andre Kuhn, Fürth (DE); Martin Hahn, Herrieden (DE)

(21) Appl. No.: 16/630,692

(22) PCT Filed: Jul. 11, 2018
(86) PCT No.: PCT/EP2018/068835

§ 371 Date: Jan. 13, 2020

(30) Foreign Application Priority Data
Jul. 14, 2017 (DE) 10 2017 115 959.2

(51) Int. Cl. B29C 51/42; B29C 51/46; B29C 45/73; B29C 45/14; B29C 45/78

(52) U.S. Cl. CPC B29C 51/422; B29C 51/46; B29C 45/73; B29C 45/1418; B29C 2945/76464; B29C 2045/14286; B29C 2945/7604; B29C 2945/76294; B29C 45/78

(57) ABSTRACT

A heating module for heating at least one film element. The heating module has two or more heating segments with in each case one or more heating elements for heating a first area of the film element assigned to the respective heating segment, wherein the heating module and/or at least one of the heating segments includes at least one sensor for measuring the state of the heating of the film element.

The invention relates to a heating module, a method for producing a molded part as well as a device for producing a molded part.

It is known to pre-heat flatware to be processed immediately before closing the deep-drawing mold or before closing the injection mold in the case of IMD methods (IMD=“In-Mold Decoration”) or before hot-stamping in the case of 3DHS methods (3DHS=“3D Hot Stamping”, see the document WO 2014053381 A1). This is in order to make the flatware more flexible and easier to process for the subsequent process steps of the above methods, for example. Nevertheless, workpieces made after carrying out the above method often display folds and/or cracks.

The object of the present invention is thus to improve the production of molded parts and in particular to avoid and/or minimize the above-mentioned problems and/or to provide an improved heating module and an improved method for producing a molded part as well as an improved device for producing a molded part.

The object is achieved by a heating module, in particular for use in a method for producing a molded part, which has two or more heating segments. Two or more of the heating segments have in each case one or more heating elements for heating a first area of the film element assigned to the respective heating segment. The heating module and/or at least one of the heating segments comprises or comprise at least one sensor for measuring the state of the heating of the film element.

The object is further achieved by a method for producing a molded part, wherein a film element is heated by means of a heating module. Two or more of the heating segments have in each case one or more heating elements for heating a first area of the film element assigned to the respective heating segment. The heating module and/or at least one of the heating segments comprises or comprise at least one sensor for measuring the state of the heating of the film element. The film element is deformed to form the molded part, in particular by means of back injection molding, deep drawing and/or building up a pressure gradient between the front and rear side of the film element.

The object is further achieved by a device which has a mold for deforming the at least one film element heated by the heating module, in particular by means of deep drawing, back injection molding and/or by applying a pressure gradient between the front and rear side of the film element, to form the molded part.

The invention is based on the knowledge that in the known methods the occurrence of folds and/or cracks is often to be attributed to an inhomogeneous and/or, in critical deformation zones, to an inadequate heating of the flatware before and/or during the deformation. Because the heating of the film element can be checked by at least one sensor and the heating of the film element can be effected differently at a local level by using two or more heating segments, the heated film element can be processed further in a manner particularly well adapted to the specific requirements of the respective deformation process, for example in a deep-drawing method, an injection-molding method, in particular an IMD method and/or a hot-stamping method, in particular a 3DHS method.

The heated film element is preferably processed further in a roll-to-roll method or a step-and-repeat method.

Advantageous embodiments of the invention are described in the dependent claims.

Preferably the sensor or at least one of the sensors detects the state of the heating of the film element contactlessly in one or more assigned second areas of the film element. The sensor or at least one of the sensors in particular detects the temperature or the surface temperature of the film element in the one or more assigned second areas of the film element.

The film element preferably consists of a suitable polyester material, such as for example PET (PET=polyethylene terephthalate) or polypropylene, polystyrene, PVC (PVC=polyvinyl chloride), PMMA (PMMA=polymethyl methacrylate), ABS (ABS=acrylonitrile butadiene styrene), polyamide and/or BOPP (biaxially oriented polypropylene).

The film element can be provided as a single-layered or multilayered film element, wherein the film element is in particular formed flexible, stretchable and/or elastic. The film element can in particular be provided as a single-layered or multilayered plate, wherein the plate is preferably formed rigid, inelastic and/or stretchable. The multilayered film element or the plate have, in particular, one or more decorative layers, metal layers, metal oxide layers, in particular reflective layers, optically active layers, in particular optically variable layers, electrically conductive layers, colored layers, in particular colored varnish layers, at least partially or completely light-transmitting layers, detachment layers, barrier layers, adhesive layers, adhesion-promoter layers, and/or plastic layers applied over the whole surface or only partially in areas of the surface.

Preferably the film element is provided as a laminating film or as a transfer film with a single-layered or multilayered carrier ply and a single-layered or multilayered transfer ply. In the case of the transfer film, the carrier ply is detached from the transfer ply during the transfer and the transfer ply is transferred during the transfer.

The thickness of the film element is between 10 μm and 500 μm, in particular between 20 μm and 250 μm.

By “state of the heating of the film element” is meant in particular the temperature of the film element. The state of the heating of the film element is thus defined in particular by the temperature at the surface, in particular the surface of the film element facing the heating module, and/or by the average temperature of the film element.

The state of the heating of the film element is preferably detected in one or more areas of the film element, in particular in one or more first and/or second areas of the film element. Preferably the sensor or at least one of the sensors detects the state of the heating of the film element or of a surface of the film element as a temperature, in particular as a surface temperature or average temperature, preferably as an absolute or relative temperature, in one or more of the first and/or second areas of the film element.

By “contactlessly” is meant here that the sensor or at least one of the sensors do not contact the film element during the detection of the state of the heating of the film element, in particular do not contact it mechanically. The sensor or at least one of the sensors preferably detect the state of the heating of the film element or one or more first and/or second areas of the film element from a predetermined distance. This distance can be, for example, between 10 mm and 250 mm.

An advantage of the contactless measurement is that the risk of damaging the film element or the surface of the film element through a contact with the sensor is avoided.

The sensor or at least one of the sensors is preferably a pyrometer. The pyrometer in particular detects the state of the heating of the film element contactlessly in an assigned second area of the film element. The pyrometer in particular detects the surface temperature of the film element in the assigned second area of the film element.

At least one of the pyrometers preferably detects the temperature of the film element in one or more first and/or second areas of the film element. Preferably at least one of the pyrometers analyzes the heat radiation radiated off the film element, wherein the temperature of the film element can in particular be determined via the level of the intensity and the position of the emission maximum of the corresponding heat radiation distribution.

Preferably the sensor or at least one of the sensors, in particular the pyrometer or at least one of the pyrometers, detects the state of the heating of the film element in an assigned second area and/or one or more second areas of the film element. The sensor or at least one of the sensors, in particular the pyrometer or at least one of the pyrometers, preferably detect the state of the heating of the film element in one or more first areas of the film element. One or more of the second areas of the film element overlap, in particular in each case or as a whole, with one or more of the first areas of the film element. One or more of the second areas of the film element preferably correspond to one or more of the first areas of the film element.

Preferably the sensor or at least one of the sensors is a thermal imaging sensor for the recording or detection of a thermal image in the form of an at least two-dimensionally formed item of heat distribution information. The sensor is in particular a thermal imaging camera. The thermal imaging sensor or the thermal imaging camera in particular detects the state of the heating of the film element in a plurality of second areas of the film element contactlessly. Preferably the thermal imaging sensor detects the state of the heating of the entire film element or in one or more of the first areas of the film element and/or in one or more of the second areas of the film element. The thermal imaging sensor detects the state of the heating of the film element in particular through the detection of IR radiation (IR=infrared radiation=electromagnetic radiation from one or more wavelength ranges or the wavelength range of the infrared part of the electromagnetic spectrum), which is in particular emitted by and/or radiated off the film element or one or more first and/or second areas of the film element.

Advantageously the thermal imaging sensor is used to detect the warming or heating process of the entire film element and to provide this for monitoring purposes. The thermal imaging sensor provides an observer with in particular at least one color-coded thermal image for a predetermined point in time, with the aid of which the observer preferably checks the state of the heating of the film element assigned in each case.

The film element can have the same optical properties over its entire surface, for example over the entire surface area of the film element in the case of a monochromatic decoration. The film element can, however, alternatively also have different optical properties in areas of the surface and thus generate different items of thermal imaging information in these respective areas of surface in particular due to different reflective and/or absorbent surface properties. These different items of thermal imaging information can be detected separately or together by the thermal imaging sensor. It is also possible for the film element to contain special markings and/or decorative elements which provides an item of thermal imaging information different from or contrasting with the respective surroundings of the marking and/or of the decorative element. This marking and/or decorative element can be used, for example, to identify particular areas of the molded part. For example, it is possible with such markings and/or decorative elements to identify and/or highlight areas of the film element or of the molded part which require a different warming or heating. It is then particularly easily recognizable visually on the thermal image which heating is present in these thus-identified areas.

Further, one or more of the sensors which are in particular assigned to one or more of the heating segments are thermal imaging sensors which each detect one or more first and/or second areas of the film element.

The measurement accuracy of the sensors, in particular of the pyrometers or of the thermal imaging sensor, is in particular limited to a measurement error of greater than or equal to −0.1 K and less than or equal to +0.1 K around a respective measured value, wherein the measurement errors are preferably symmetrical or asymmetrical. The measurement error is preferably limited to a variation of greater than or equal to −0.1 K and less than or equal to 0.1 K around the measured value.

Preferably one or more of the heating segments comprise in each case the sensor or at least one of the sensors. The second area or at least one of the second areas of the film element, in which the sensor or sensors preferably detect the state of the heating of the film element, overlap, in particular at least partially, with a first area of the film element assigned to the respective heating segment.

It has proved advantageous if in each case a first area of the film element is assigned to each heating segment and in each case a second area of the film element is assigned to each sensor, wherein in particular each heating segment in each case has a sensor. Through such an arrangement each heating segment has a sensor, which detects the state of the heating in an assigned second area of the film element, and is assigned to a first area of the film element which is heated by the heating segment. It has proved particularly advantageous if the respective first area and the respective second area overlap in such a way that both areas are no longer distinguishable from each other.

Preferably the second area or at least one of the second areas of the film element, in which the sensor or sensors preferably detect the state of the heating of the film element, is in particular arranged within the first area of the film element assigned to the respective heating segment.

Preferably the sensor or one of the sensors detects the state of the heating of the film element in two or more second areas of the film element. In particular the second areas of the film element overlap, in each case at least partially, one of the first areas of the film element. Preferably a single second area respectively is assigned to one of the first areas respectively.

Preferably at least two of the two or more heating segments are arranged movable relative to each other in the heating module. Preferably the heating module has an adjusting device by means of which the relative positional arrangement of two or more of the heating segments, in particular to each other, can be altered. In particular one or more of the heating segments in the heating module are mounted displaceable in the vertical or horizontal direction and/or one or more of the heating segments in the heating module are mounted tiltable. The horizontal or vertical position and/or the tilt angle can in particular be adjusted by means of the adjusting device. Preferably the horizontal or vertical position and/or the tilt angle can be adapted or adjusted to the contour of the film element.

The geometry of the film element and/or the molded part and/or a cavity and/or a male mold or a male die can resemble a flat or curved surface and/or a body extended particularly markedly in two directions and extended only slightly in one direction. To determine the contour or the contour progression of the film element or the molded part, in particular of the curved film element or molded part, the curvature or the radius of curvature is determined at a plurality of points of the film element or the molded part or at a plurality of location coordinates of the film element or the molded part in order to detect the geometric shape of the film element or the molded part. A two-dimensional film element or of the molded part has, parallel to at least one direction, a curvature progression along this at least one direction. The contour or the contour progression of the film element or the molded part is preferably described by means of the average curvature or the GauB curvature.

A section of the film element or the molded part along any desired direction parallel to the plane spanned by the two extended directions of the film element or the molded part preferably follows a curve curved at least in sections, in particular an open curve curved at least in sections, wherein the curve is, for example, a part of a closed curve. One or more of the contours and/or one or more of the contour progressions of the film element or the molded part follow a curve curved on one side, with the result that preferably the sign of the curvature is the same everywhere, with the result that in particular the curvature of at least one curve does not change its sign. In particular the curve is a one- or two-dimensional curve.

By a curvature is meant in particular a local deviation of a curve and/or contour from a straight line. By the curvature of a curve or contour is meant in particular one change in direction per length and/or stretch passed through of a sufficiently short curve piece or contour piece or curve progression and/or contour progression. The curvature of a straight line and the curvature of a flat surface is equal to zero everywhere. A circle with a radius r has the same curvature everywhere, namely 1/r. In the case of most curves or contours, the curvature changes from point to point, in particular the curvature changes continuously from point to point. The curvature of a curve or contour at a point P thus indicates how much the curve or contour deviates from a straight line or a flat surface in the immediate surroundings of the point P. The amount of the curvature is called the radius of curvature and this corresponds to the inverse value of the amount of a local radius vector. The radius of curvature is the radius of the circle which represents the best approximation in the local surroundings of the contact and/or tangential point P of a curve or contour.

Tests have advantageously shown that predetermined first areas of the film element are heated in particular more evenly or more homogeneously when the heating segment assigned at least to the first area of the film element is moved and arranged in the direction of the first area of the film element with respect to the possible surrounding heating segments. Here, for example, first areas of the film element which have small radii of curvature are heated more homogeneously than when the assigned heating segments remains at a constant distance.

Further, it is advantageous to arrange one of the heating segments with respect to the possible surrounding heating segments closer to the corresponding assigned first area of the film element in order to achieve, for example, a higher temperature in the corresponding assigned first area of the film element than in the surrounding one or more first areas of the film element.

It has proved advantageous to tilt and/or displace one or more of the heating segments with respect to the film element in such a way that the first areas of the film element assigned to the one or more heating segments are heated more quickly and/or strongly. The smaller the distance of one of the heating segments with respect to the assigned first area of the film element, the better the heat transfer, in particular the contactless heat transfer, from the corresponding heating segment to the assigned first area of the film element and the faster the assigned first area is heated. Electricity and power costs can be saved and the environment can be protected through the displaceability and/or tiltability of the heating segments and the more efficient heating of the film element hereby achieved.

Preferably the adjusting device has one or more electric servomotors and/or one or more pneumatic and/or hydraulic actuators by means of which in particular the relative positional arrangement of two or more of the heating segments to each other can be altered.

The use of electric servomotors and/or pneumatic and/or hydraulic actuators for altering the relative positional arrangement of two or more of the heating segments to each other, the advantage results that the heating segments need not be adjusted manually, but rather are adjusted, for example, from a computer which is connected to the adjusting device of the heating segments, in particular via one or more drivers.

It is particularly advantageous if the heating module and/or the device for producing a molded part is provided with an electrical control device, in particular a computer, and/or is actuated by an electrical control device, in particular a computer, and/or the method for producing the molded part is carried out controlled by an electrical control device, in particular a computer.

It has proved advantageous that the control device controls one or more of the heating segments via one or more first control loops and/or controls the adjusting device via one or more second control loops. In particular the state of the heating of the film element detected by the at least one sensor and/or data on the contour of the molded part and/or a target temperature profile of the film element serves as input parameters of the first and/or second control loops.

In order to adjust the heat output and/or the positioning of the heating segments, the control device preferably proceeds as follows:

The control device sends to one or more of the sensors the command to detect the temperature in one or more second areas of the film element assigned to the sensors and to send the detected data back to the control device. The actual temperature value distribution of the film element is hereby detected by the control device. The actual temperature value distribution together with a predetermined target temperature value distribution is used as input parameter of a control loop, by means of which the control device actuates the heating segments and/or the adjusting device. If the control device ascertains, for example, a difference between the actual temperature value of one of the second area assigned to one of the heating segments by the sensor and the target temperature value of the first area assigned to the heating segment, then the heat output is reduced or increased, in particular on the basis of the control algorithm of the control loop, in such a way that an alignment of the temperatures preferably takes place. Preferably feedback of this temperature control takes place iteratively over successive measurements until the sensors detect actual temperature values in the respective assigned second areas which correspond to the provided target temperature values of the film element up to a predetermined tolerance.

Preferably one or more of the heating elements are formed by a ceramic heating element or an IR heating element, wherein the heating elements have in particular at least one heat-generating medium. The heat-generating medium is provided, for example, by heating pipes or also electrically operated heating conductors heating up due to their electrical resistance, which have in particular a length of between 50 mm and 10,000 mm. One or more of the heating segments have in particular a segment size in at least one of the lateral directions of between 50 mm and 2500 mm, preferably between 100 mm and 500 mm. The respective directions parallel to the width, height and depth of the heating element are called lateral directions. One or more of the heating elements have, for example, a width of between 20 mm and 2500 mm and/or a height of between 50 mm and 2500 mm and/or a depth of between 25 mm and 75 mm. Neighboring heating segments preferably have a segment spacing of between 0 mm and 150 mm, in particular between 0 mm and 75 mm. The heating elements have in particular a heating accuracy of greater than −0.1 K and less than 0.1 K.

Preferably two or more heating segments are arranged offset relative to each other in the vertical direction in the heating module, wherein the heating segments are, for example, arranged offset relative to each other in such a way that each of the heating segments has in particular the same distance from the respective assigned first area of the film element within a predetermined tolerance. The arrangement of the heating segments in the vertical direction preferably follows the arrangement the first areas of the film elements assigned to the heating segments at a predetermined constant or variable distance. The respective distance of one or more of the heating segments from the film element or from the respective first areas of the film element assigned to the heating segments is between 20 mm and 2000 mm, in particular between 25 mm and 500 mm, particularly preferably between 25 mm and 250 mm.

In particular, it is important that the distance of the heating segments from the film element in an x-direction should be approximately once to twice, preferably 1.5 times, as large as the distance of the heating segments from each other in a y-direction, wherein the x-direction and the y-direction are preferably arranged perpendicular to each other.

In particular, it is furthermore important that if the distance of the heating segments from the film element is doubled the heat output of the heating segments has to be doubled in order to be able to provide approximately the same or an equivalent amount of energy on the surface of the film element for the heating.

Preferably the device has a heating module, in particular in one of the embodiments described above, and a mold for deforming the at least one film element heated by the heating module, in particular by means of deep drawing, back injection molding and/or by applying a pressure gradient between the front and rear side of the film element, as well as to form the molded part.

Preferably the mold has two mold halves between which the film element can preferably be arranged. The heating module is in particular arranged in an upper and/or lower mold half and/or a first and/or second mold half in such a way that the film element can be heated by means of the heating module preferably after closing the mold halves. In particular, the mold has means for applying a pressure gradient between the front and rear side of the film element in such a way that the film element is deformed to form the molded part in particular by the pressure gradient between the front and rear side of the film element. The pressure gradient between the front side and the rear side of the film element is provided, for example, by applying a vacuum or a negative pressure between the film element and the lower mold half and/or by applying an excess pressure between the film element and the upper mold half.

The generation or destruction of the pressure difference between the front side and the rear side of the film element is in particular effected in such a way that the magnitude of the pressure difference is increased or reduced over at least one specified or unspecified time interval, wherein the magnitude of the pressure difference preferably depends on the time via a functional relationship. The increase in the magnitude of the pressure difference over a specified time interval follows a sigmoid function, for example.

Preferably the device has a molding station which in particular comprises the mold. The device preferably has a carriage for receiving the film element. The device has in particular a transport device for transporting the film element by means of the carriage to the heating module and to the molding station.

Preferably the mold comprises the first mold half and the second mold half. The film element can in particular be arranged between the first mold half and the second mold half the film element. The mold optionally has in particular a clamping device for clamping the film element. The heating module is preferably mounted movable in such a way that the heating module can preferably be moved in between the film element and the second mold half and moved out before closing the mold halves. The first and/or the second mold half has in particular at least one injection channel for injecting a material melt.

Preferably the heat output of the two or more heating segments is set or adjusted in each case individually, wherein the setting or adjustment of the heating segments is effected manually or by means of at least one control loop and/or by means of at least one computer. The heat output of the heating segments is in particular effected via one or more control loops which are connected to one or more of the sensors of the heating segments, wherein the sensor or sensors preferably detect the state of the heating of the film element by means of at least one control loop and/or by means of at least one computer. Preferably the heat output of at least one of the heating segments is set or adjusted by means of a comparison between the actual value of the state of the heating of the film element and the target value of the state of the heating of the film element. In particular the heat output of at least one of the heating segments is set or adjusted on the basis of the state of the heating of the film element detected by the at least one sensor.

Preferably the heat output of at least one of the heating segments is set or adjusted on the basis of the state of the heating of the film element detected by the at least one sensor as well as a predefined target temperature value profile of the film element determined by the contour design of the molded part, wherein the setting or adjustment of the heat output of the at least one heating segment is in particular effected by means of at least one control loop which is preferably connected to the at least one sensor and the at least one heating element.

Preferably the heat output of at least one of the heating segments is set or adjusted on the basis of the state of the heating of the film element detected by the at least one sensor as well as data on the contour of the molded part.

Preferably the positioning of the heating segments is set or adjusted on the basis of data on the contour of the molded part, wherein the data on the contour of the film element comprise one or more of the following data: presence and position of curvatures of the contour, radius of curvature, direction of curvature, spacing from a reference surface, in particular reference plane, vertical or horizontal spacing of an area of surface of the contour from one or more of the heating segments, position of recesses and/or through-holes of the molded part.

Preferably the heat output of at least one of the heating segments is set or adjusted on the basis of the state of the heating of the film element detected by the at least one sensor in the first area of the film element assigned to the heating segment and/or in the first area of the film element assigned to another of the heating segments.

Preferably one or more of the heating segments in the adjusting device are mounted displaceable in the vertical or horizontal direction and/or one or more of the heating segments in the heating module are mounted tiltable. The horizontal or vertical position and/or the tilt angle of one or more of the heating segments in the heating module can be adjusted by means of the adjusting device, in particular can be adjusted to the contour of the film element.

The method for producing the molded part preferably comprises arranging the film element between two mold halves. Further method steps comprise closing the mold halves and/or heating the film element in particular by means of the heating module, which is preferably arranged in the upper and/or lower mold half and/or the first and/or the second mold half. The film element is preferably deformed by applying a pressure gradient between the front and rear side of the film element to form the molded part. In particular the molded part is removed in a further method step.

The method for producing a molded part further comprises a method step in which the film element is preferably inserted into a carriage and transported by means of the carriage to the heating module. In particular the heating module heats the film element inserted into the carriage, wherein the film element is heated to a temperature of between 50° C. and 500° C., in particular between 100° C. and 300° C. The film element is preferably transported by means of the carriage to a molding station. Preferably the film element is deformed in the molding station to form the molded part. Preferably the molded part is removed from the molding station in a further method step, in particular after the formation of the molded part.

The method for producing a molded part further comprises further method steps: in particular inserting the film element and/or moving the heating module in such a way that it is preferably arranged above the film element, preferably heating the film element by the heating module and/or deforming the film element in particular by applying a pressure gradient between the front and rear side of the film element to form the molded part. Preferably the molded part is removed in a further method step, in particular after the formation of the molded part.

The method for producing a molded part preferably comprises the method steps: arranging the film element between a first mold half having a cavity and/or a male die and a second mold half, wherein the cavity and/or the male die or the male mold has in particular a one-dimensionally or two-dimensionally aligned surface structure. Preferably the shape of the cavity and/or of the male die follows a two-dimensional surface, wherein the surface is in particular characterized by at least one curvature progression in at least one predetermined direction. Preferably the heating module is moved in between the film element and the second mold half and/or heated by the heating module. In an optional method step, the film element is clamped onto the first mold half by means of a first clamping device. In a further optional method step, the film element is in particular deformed by the provision of a negative pressure or vacuum between the first mold half and the film element in such a way that the film element preferably follows the contour of the cavity and/or of the male die. In particular, a further method step comprises moving the heating module out, wherein the heating module is preferably moved out of the space between the first mold half and the film element. The first mold half and the second mold half are closed, in particular in a further method step. The formation of the molded part is in particular effected by injecting a material melt through at least one injection channel in the first mold half and/or the second mold half. Two further method steps preferably comprise opening the first mold half and second mold half as well as optionally opening the clamping device or removing the molded part.

In a further preferred method step in the method for producing a molded part, a cavity is provided between the film element and the first and/or second mold half by closing the first mold half and the second mold half.

In an embodiment, the first and/or the second mold half comprise the heating module and/or one or more of the sensors.

It is possible for the heating segments and/or the sensors to be arranged behind the wall of the respective mold half and to heat the wall directly and in particular locally in each case to different extents. The heating segments can be electrically operated and in particular act inductively on the mold half and/or can also be hydraulically operated with a heated flowing liquid in heating channels. Because the wall is arranged very close next to the film element and its shape already follows the three-dimensional shape of the molded part, the film element can be heated evenly over the entire surface. A time-consuming moving-in and moving-out of a separate movable heating module can be dispensed with, which can reduce the cycle time.

In the following the invention is explained with reference to several embodiment examples utilizing the attached drawings by way of example. There are shown in:

FIG. 1 shows a schematic representation of a heating module

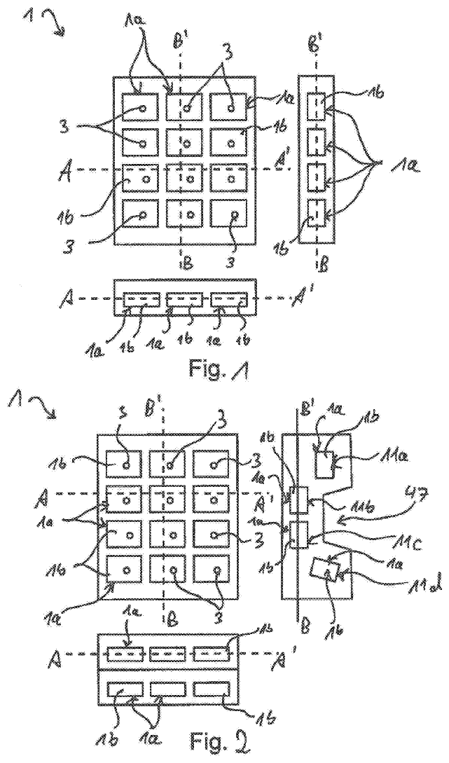

FIG. 2 shows a schematic representation of a heating module

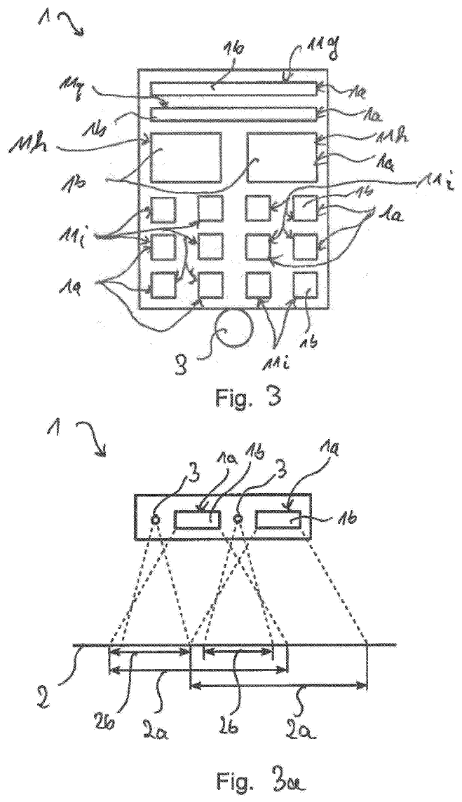

FIG. 3 shows a schematic representation of a heating module

FIG. 3a shows a schematic representation of a heating module

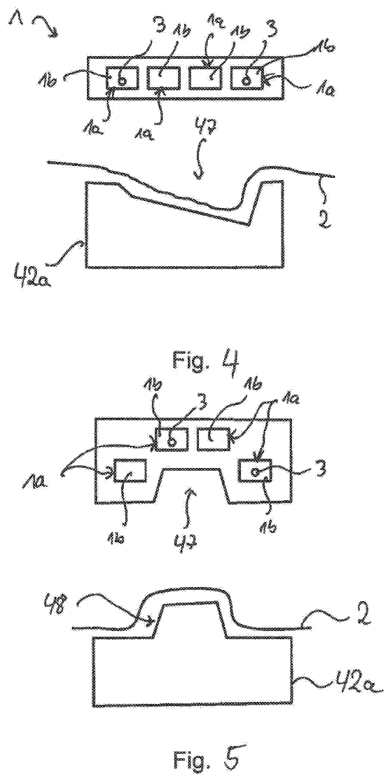

FIG. 4 shows a schematic representation of a device

FIG. 5 shows a schematic representation of a device

FIG. 6 shows a schematic representation of a device

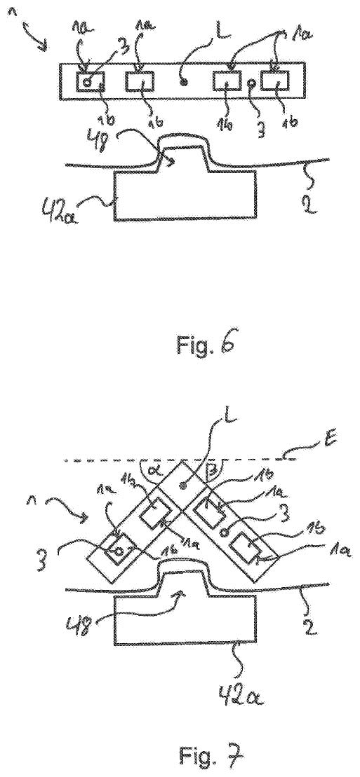

FIG. 7 shows a schematic representation of a device

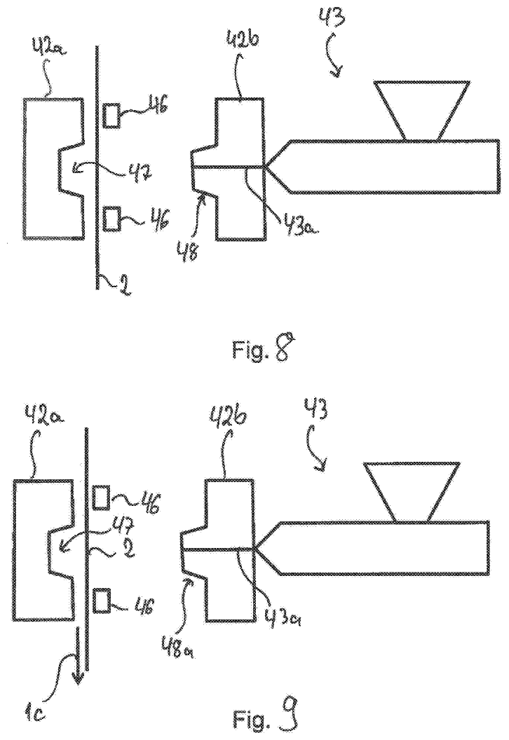

FIG. 8 shows a schematic representation of a device and a method step

FIG. 9 shows a schematic representation of a device and a method step

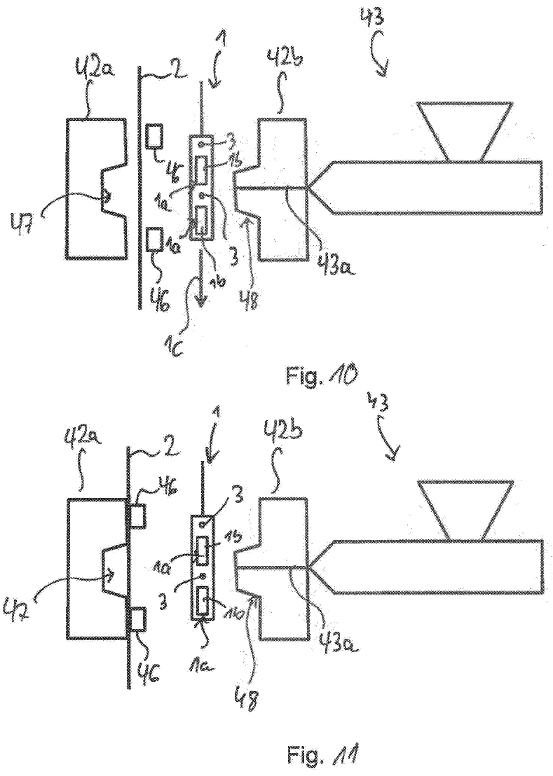

FIG. 10 shows a schematic representation of a device and a method step

FIG. 11 shows a schematic representation of a device and a method step

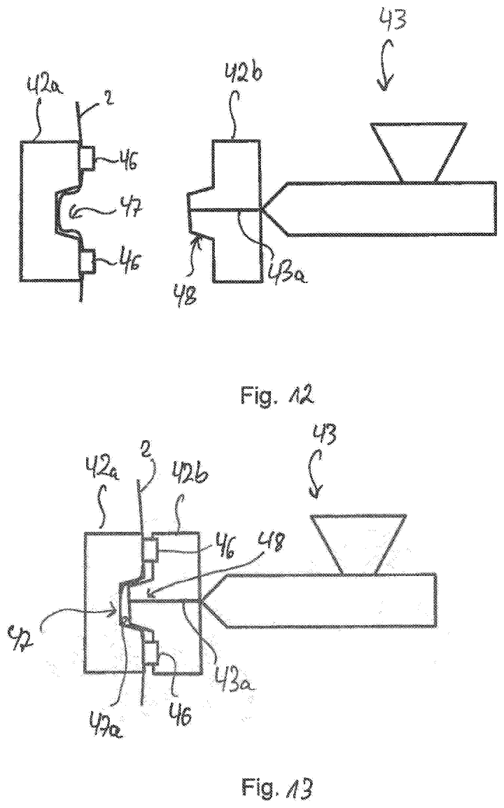

FIG. 12 shows a schematic representation of a device and a method step

FIG. 13 shows a schematic representation of a device and a method step

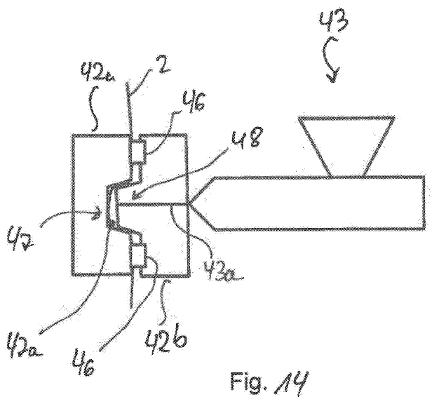

FIG. 14 shows a schematic representation of a device and a method step

FIG. 15 shows a schematic representation of a device and a method step

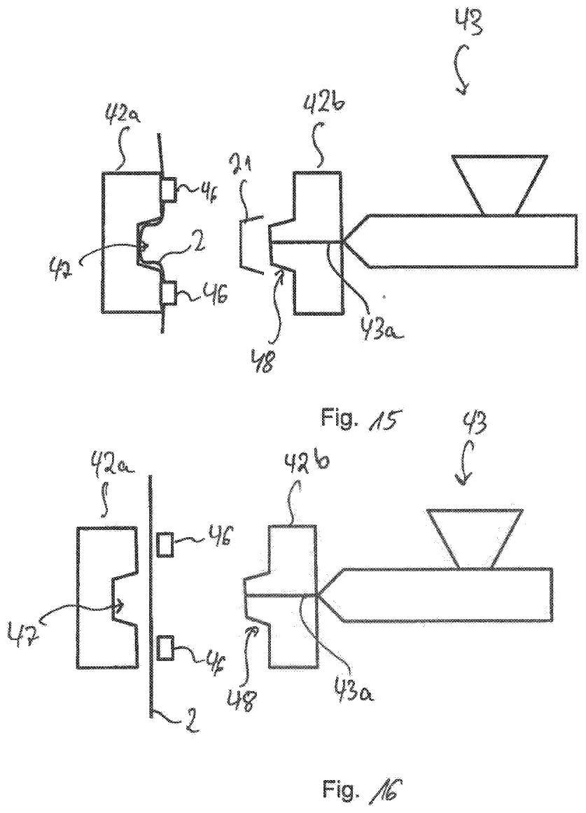

FIG. 16 shows a schematic representation of a device and a method step

FIG. 1 shows a top view of a heating module 1 comprising twelve heating segments 1a, which each have at least one heating element 1b. On the right-hand side next to the heating module, a first cross section of the heating module 1 along the axis B-B′ is shown, and underneath the heating module 1, a second cross section of the heating module along the axis A-A′ is shown. The twelve heating segments 1a are arranged in three columns with respect to the direction denoted by the axis A-A′ and in four rows with respect to the direction denoted by the axis B-B′ in the heating module 1 shown, and each have a sensor 3.

The first cross section and the second cross section of the heating module 1 comprise four or three heating segments 1a, which are in each case equidistant from each other. All of the four heating segments have the same orientation or the same angle with respect to the axis B-B′ or the axis A-A′ and are not arranged displaced relative to one another.

The heating module 1 is preferably used in methods for producing molded parts to heat film elements, before they are processed further, for example by an injection-molding method, in particular a back injection-molding method, a deep-drawing method and/or a hot-stamping method.

The segment sizes of the heating segments 1a in at least one lateral direction, for example along the directions denoted by the sections A-A′ and/or B-B′, are between 50 mm and 2500 mm, in particular between 100 mm and 500 mm. Neighboring heating segments preferably have a segment spacing of between 0 mm and 150 mm, in particular between 0 mm and 75 mm, with respect to each other.

It has proved advantageous to form one or more of the heating segments 1a or one or more of the heating elements 1b as lasers or to arrange one or more lasers, which preferably emit heat-generating radiation, in particular IR radiation, in one or more areas of the segment spacings, in particular between the heating segments 1a or the heating elements 1b.

Preferably one or more of the heating elements 1b are formed by a ceramic heating element or an IR heating element. In particular a first portion of the one or more heating elements 1b is in each case formed by a ceramic heating element and a second portion of the one or more heating elements 1b is in each case formed by an IR heating element.

Preferably the heating module 1 and/or at least one of the twelve heating segments 1a has at least one sensor 3 for measuring the state of the heating of the film element. One or more of the sensors 3 are in particular pyrometers, which measures the temperature, preferably the surface temperature in at least one assigned second area of the respective film element 1. One or more of the sensors 3 are preferably formed as thermal imaging cameras.

FIG. 2 shows a heating module 1 comprising twelve heating segments 1a, which each have one or more heating elements 1b and wherein each of the heating segments 1a comprises a sensor 3. The heating segments 1a are arranged in the heating module 1 in three columns with respect to the direction denoted by the axis A-A′ and in four rows with respect to the direction denoted by the axis B-B′. On the right-hand side next to the heating module 1 shown, a third cross section of the heating module 1 along the axis B-B′ is shown, and underneath the heating module 1 shown, a fourth cross section of the heating module 1 shown along the axis A-A′ is shown.

The third cross section of the heating module 1 comprises four heating segments 1a and has a cavity 47. The four heating segments 1a are not arranged along one plane, but rather two heating segments 11a, 11d are arranged in each case on one of two planes, with the result that the distances of the four heating segments 1a from the cavity follow the contour of the cavity. As a result the average of the distances of the four heating segments from the cavity is smaller than when the four heating segments 1a are arranged along one plane. The heating segment 11d is arranged tilted with respect to the heating segments 11a, 11b and 11c.

The fourth cross section comprises six heating segments 1a, wherein three of the heating segments are arranged a first one of the planes and three of the heating segments are arranged on a second one of the planes.

In particular, at least two or more of the heating segments 1a are arranged movable relative to each other, preferably at least one of the directions denoted by the axes A-A′ and B-B′, movable in the heating module 1.

Preferably one or more of the heating segments 1a are arranged offset in the vertical direction, in particular in a direction perpendicular to the directions denoted by the axes A-A′ and/or B-B′, in the heating module 1.

It has proved particularly advantageous to provide the heating module 1 with an adjusting device by means of which the relative positional arrangement, in particular the positional arrangement in the vertical direction, of the heating segments 1a to each other can be altered. For example, this makes it possible to reduce at least one distance of an assigned heating segment 1a from a contour.

Preferably one or more of the heating segments 1a in the heating module are mounted displaceable in the vertical and/or horizontal direction, wherein the vertical direction is perpendicular to the plane spanned by the heating module 1 and the horizontal direction lies in the plane spanned by the heating module 1. The horizontal direction runs, for example, parallel to the directions denoted by the axes A-A′ or B-B′. Preferably the vertical and/or the horizontal position of the respective heating segments 1a or the position of the heating segments 1a on at least one of the vertical and/or horizontal directions can be adapted by means of the adjusting device, in particular can be adjusted or adapted to the contour of the film element 2. In particular the tilt angle of one or more heating segments 1a with respect to an axis, preferably with respect to one of the vertical and/or horizontal axes, can be adapted or adjusted by means of the adjusting device.

The adjusting device preferably has one or more servomotors and/or one or more pneumatic and/or hydraulic actuators by means of which the relative positional arrangement of two or more of the heating segments 1a to each other can be altered.

FIG. 3 shows a top view of the a heating module 1 comprising sixteen heating segments 1a, which each have at least one heating element 1b. The in each case two heating segments 11g and 11h have a rectangular shape lying in the plane spanned by the heating module. Here, the two heating segments 11g are arranged in one column and two rows and the two heating segments 11h are arranged in one row and two columns. The twelve heating segments 11i are arranged in four columns and three rows.

Preferably one or more of the heating segments 1a in each case have at least one heating element.

The heating module 1 has a sensor 3b, which is arranged with or without spacing next to the heating module. The sensor 3b is in particular formed as a thermal imaging camera.

FIG. 3a shows a cross section of a heating module 1 comprising two heating segments 1a and two sensors 3 as well as a film element 2. In each case a first area 2a of the film element 2 is assigned to the heating segments 1a and in each case a second area 2b of the film element 2 is assigned to the sensors 3.

It has proved particularly advantageous that the one or more sensors 3 detect the state of the heating, in particular the surface temperatures, of the film element 2 in particular contactlessly in the one or more assigned second areas 2a of the film element 2, since the film element 2 can be damaged in the case of a non-contact-free temperature measurement, for example through temporary adhesions and/or adhesive bondings to contacting sensors.

Preferably one or more of the second areas 2b of the film element 2, in which one or more of the sensors 3 assigned to the second areas detect the state of the heating, in particular the surface temperature, of the film element 2, at least partially overlap with the first area 2a of the film element 2 assigned to the respective heating segment 1a.

Preferably one or more of the second area 2b or at least one of the second areas 2b of the film element 2, in which the one or more sensors 3 detect the state of the heating of the film element 2, are arranged within the first area 2a of the film element 2 assigned to the respective heating segment 1a.

Particularly preferably the one or more sensors 3 detect the state of the heating of the film element 2 in two or more second areas 2b of the film element 2 and in each case the second areas 2b at least partially overlap one of the one or more first areas 2a.

It has proved advantageous that at least one of the sensors 3 is formed as a thermal imaging camera which detects the state of the heating of the film element 2 in a plurality of second areas 2b of the film element 2 contactlessly. Here the thermal imaging camera in particular detects the entire area of the film element 2.

It has proved particularly advantageous to designate at least one thermal imaging camera and at least one pyrometer for measuring the temperature, in particular the surface temperature, in one or more second areas 2b of the film element 2 or for measuring the temperature distributions, in particular the surface temperature distributions, in one or more second areas 2b of the film element 2. For example, the surface temperature of an assigned second area 2b can be detected by means of the pyrometer and at the same time the surface temperature of the entire film element 2, in particular comprising the second assigned area 2b, can be detected by means of the thermal imaging camera, with the result that two measuring channels are available for the surface temperature.

FIG. 4 shows a cross section of a device comprising a heating module 1 and a first mold half 42a, wherein the first mold half 42a has a cavity 47. A film element 2 is arranged between the heating module 1 and the first mold half 42a. The film element 2 follows the contour of the 47. The heating module 1 comprises four heating segments 1a, wherein two of the heating segments 11j each have a sensor 3, in particular at least one pyrometer, preferably a thermal imaging camera.

FIG. 5 shows a cross section of a device comprising a heating module 1 and a first mold half 42a, wherein the heating module 1 has a cavity 47 and wherein the first mold half 42a has a male die 48 or a male mold 48. A film element 2 is arranged between the heating module 1 and the first mold half 42a. The heating module 1 has four heating segments 11k, 11l, 11m, 11n, wherein two of the heating segments 11l and 11n have a sensor 3, in particular a pyrometer, preferably a thermal imaging camera. Two of the heating segments 11k and 11n are offset with respect to the remaining two heating segments 11l and 11m in such a way that all of the heating segments 11k, 11l, 11n, 11 m have the same distance, within a tolerance, from the first mold half 42a comprising the male mold 48. The arrangement of the heating segments 11k, 11l, 11n, 11 m preferably follows the contour of the male mold 48.

Preferably the contour of the male mold 48 of the first mold half 42a and the contour of the cavity 42a of the heating module 1 are formed in such a way that both contours are in particular complementary to each other.

FIG. 6 shows a cross section of a device comprising a first mold half 42a and a heating module 1, wherein the first mold half 42a has a male mold 48 and wherein the heating module 1 has two heating segments 1a with in each case a sensor 3, in particular in each case a pyrometer, preferably in each case a thermal imaging camera. A film element 2 which follows the contour of the male mold 48 is arranged between the first mold half 42a and the heating module 1. The heating module 1 comprises two wings 12a and 12b which each have a sensor 3, wherein the wings 12a, 12b are mounted rotatable about an axis L.

Preferably each of the wings 12a, 12b preferably has at least one sensor 3.

FIG. 7 shows the cross section, shown in FIG. 6, of a device except for the fact that the wing 12a is rotated at the angle α about the axis L with respect to the position of the wing 12a shown in FIG. 6 in the direction of the first mold half 42a, and the wing 12b is rotated at the angle β about the axis L with respect to the position of the wing 12b shown in FIG. 6 in the direction of the first mold half 42a, in particular of the reference plane E. The angles α, β are preferably identical or different.

Advantageously the respective distances between the heating segments 1a are reduced due to the rotation of the wings 12a, 12b, since the wings 12a, 12b of the heating module 1 here approximate the contour of the male mold 48 of the first mold half 42a and/or hereby follow the shape of the male mold 48 of the first mold half 42a.

In particular the first mold half 42a has a cavity 47 or at least one cavity 47 and/or at least one male mold 48 in place of the male mold 48.

FIGS. 8 to 17 each show a device for producing a molded part in states which correspond to different method steps of a method for producing a molded part.

The device for producing a molded part has a heating module 1 and a mold for deforming the at least one film element 2 heated by the heating module 1. The deformation of the heated film element 2 is in particular effected by means of deep drawing, back injection molding and/or by applying a pressure gradient between the front side and the rear side or between a first side and a second side of the film element 2. The mold provides the molded part.

The mold preferably has two mold halves, between which the film element 2 can be arranged. The film element 2 is preferably arranged in the upper and/or lower or the first and/or second mold half in such a way that the film element can be heated by means of the heating module 1 after closing the mold halves. The mold has in particular means for applying a pressure gradient between the front side and the rear side or the first side and the second side of the film element 2 in such a way that the film element 2 is deformed by pressure gradients between the front side and the rear side of the film element 2 or the first and the second side of the film element 2 to form a molded part.

The device for producing a molded part further preferably has a molding station which comprises the mold. The device has in particular a carriage for receiving the film element 2. Preferably the device comprises a transport device for transporting the film element 2 by means of the carriage to the heating module 1 and to the molding station.

The mold further preferably has a first and a second mold half 42a, 42b, wherein the film element 2 can in particular be arranged between the first and the second mold half 42a, 42b. The mold preferably has a clamping device for clamping the film element 2. The heating module 1 of the device is in particular mounted movable in such a way that the heating module 1 can be moved in between the film element 2 and the first mold half 42a or the second mold half 42b and moved out before closing the mold halves 42a, 42b. The first and/or the second mold half preferably have at least one injection channel for injecting a material melt.

FIG. 8 shows a device for producing a molded part comprising a mold which has a first mold half 42a comprising a cavity 47 and a second mold half 42b comprising a male mold 48, wherein the contour of the cavity 47 and the contour of the male mold 48 are complementary to each other apart from predetermined differences and/or tolerances. A film element 2 and a clamping device 46 is arranged between the first mold half 47 and the second mold half 48. The second mold half has an injection channel 43a through which material melt from the injection device 43 is preferably forced.

The clamping device 46 preferably clamps the film element 2 onto the first mold half 42a. In particular the clamping device 46 clamps the film element 2 onto the second mold half 42b.

FIG. 9 shows the moving of the film element 2 along the direction 1c, which lies in the plane spanned by the film element 2, into the device for producing a molded part shown in FIG. 8. The film element 2 contacts neither the clamping device 46 nor the first or the second mold half 42a, 42b. The first mold half 42a and the second mold half 42b do not contact each other.

FIG. 10 shows the device for producing a molded part shown in FIG. 9 except for the fact that a heating module 1 is moved in between the film element 2 and the second mold half 42b as well as the clamping device 46 and the second mold half 42b. The direction of movement 1c of the heating module 1 preferably runs parallel to the plane spanned by the film element 2. The heating module 1 comprises three heating elements 1a, which each have at least one or more heating elements 1b, as well as four sensors 3, which are arranged next to and/or in each case between the heating segments 1a.

FIG. 11 shows the device for producing a molded part shown in FIG. 10 except for the fact that the clamping device 46 clamps the film element 2 onto the first mold half 42a, with the result that the film element 2 is clamped between the clamping device 46 and the first mold half 42a.

Preferably the heating module 1 heats the clamped film element 2, wherein in particular in each case a first area 2a of the film element 2a, which is heated by the respective heating segment 1a, is assigned to each of the three heating segments 1a of the heating module 1.

One or more of the four sensors 3 of the heating module 1 are in each case assigned to one or more second areas 2b of the film element 2. Preferably the one or more sensors 3 in each case assigned to the respective one or more second areas 2b detect the state of the heating, in particular the temperature, preferably the surface temperature, of the respective one or more second areas 2b of the film element 2.

The respective heat output of one or more of the heating segments 1a is in particular set or adjusted individually, wherein the respective heat outputs of the one or more heating segments 1a are set or adjusted, for example, via one or more control loops of the state of the heating of the film element 2. For this, the control loops preferably couple the heat outputs of the respective heating segments 1a to the measurements of the sensors 3 with respect to the state of the heating of the film element 2.

The heat output of one or more of the heating segments 1a is further preferably set or adjusted on the basis of the state of the heating of the film element 2 detected by the at least one sensor 3. In particular the heat outputs of all heating segments 1a are set or adjusted with reference to the measurement or detection of the state of the heating of the film element 2 or of one or more second areas 2b of the film element 2 by a sensor 3, wherein the sensor 3 can be formed, for example, as a pyrometer or as a thermal imaging camera.

Preferably the heat output of at least one of the heating segments 1a is set or adjusted on the basis of the state of the heating of the film element 2 detected by the at least one sensor 3, in particular in one or more of the second areas 2b of the film element 2, in the first area 1a of the film element 2 assigned to the heating segment 1a. The heat output of at least one of the heating segments 1a is preferably set or adjusted on the basis of the state of the heating of the film element 2 detected by the at least one sensor 3 in the first area 2a of the film element 2 assigned to another of the heating segments 1a.

Further, one or more of the sensors 3 detect the state of the heating of the film element 2 contactlessly, i.e. without mechanical contact with each other, in one or more assigned second areas 2b of the film element 2. In particular the surface temperature of the film element 2 is detected contactlessly in the one or more second areas 2b of the film element 2 assigned to the corresponding sensors 3.

Furthermore, one or more of the second area 2b of the film element 2, in which one or more of the sensors 3 detect the state of the heating, are arranged in such a way that the second areas 2b at least partially overlap at least one of the first areas 2a, are in particular arranged at least partially within at least one of the first areas 2a.

It has proved particularly advantageous if the heating module 1 has an adjusting device by means of which the relative position of two or more of the heating segments 1a to each other, in particular along any desired directions, can be altered. Preferably one or more of the heating segments 1a in the heating module 1 are mounted displaceable and/or tiltable in the vertical or horizontal direction. The horizontal or vertical position of one or more of the heating segments 1a, in particular along predetermined axes in space, is preferably adjusted by means of the adjusting device. Preferably the tilt angles of one or more of the heating segments 1a, in particular with respect to a predetermined plane, are adjusted by means of the adjusting device, particularly preferably adjusted to the contour of the film element 2.

Preferably the heat output of at least one of the heating segments 1a is set or adjusted on the basis of the state of the heating of the film element 2 detected by the at least one sensor 3, in particular in a second area 2b of the film element 2 assigned to the sensor 3. Additionally or exclusively, the heat output of the heating segment 1a is set or adjusted by the contour or the contour design of the molded part, in particular of the molded part to be produced by the method, determined target temperature profile of the film element 2.

The heat output of at least one of the heating segments 1a is further preferably set or adjusted on the basis of the state of the heating of the film element 2 detected by the at least one sensor 3 as well as data on the contour of the molded part, in particular of the molded part to be produced by the method. The data are generated, for example, during the design of the molded part to be produced.

Preferably the positioning of the heating segments 1a is set or adjusted on the basis of data, in particular predetermined data, on the contour of the molded part. One or more of the heating segments 1a are for example positioned in such a way that the average distance of the heating segments 1a from the contour of the film element 2 is at a minimum and/or none of the heating segments 1a contacts the film element 2.

In particular the data on the contour of the film element 2, in particular the predetermined data on the contour of the film element 2, comprise: presence and position of curvatures of the contour, in particular of the direction-dependent curvatures of the contour, the radius of curvature, in particular the radius of curvature at every point of the contour, the direction of curvature, the spacing from a reference surface E and/or a reference plane, the vertical and/or horizontal spacing of an area of surface of the contour, in particular from the contour of one or more of the first and/or second areas 2a, 2b of the film element 2, from one or more of the heating segments 1a, the positions and/or locations of one or more recesses and/or through-holes of the molded part, in particular of the molded part to be produced in the method.

The spacing between the one or more heating segments 1a is preferably in each case between 0 mm and 150 mm, in particular between 0 mm and 75 mm. The duration of the heating of the film element 2 by the heating module 1 and/or one or more of the heating segments 1a is in each case between 1 s and 60 s, in particular between 5 s and 30 s. Preferably the film element 2 or one or more of the first and/or second areas 2a, 2b of the film element 2 are heated by the heating by means of the heating module 1 to a temperature of between 50° C. and 500° C., in particular between 100° C. and 300° C.

FIG. 12 shows the device for producing a molded part shown in FIG. 11 except for the fact that the heating module 1 is no longer moved in between the film element 2 and the second mold half 42b, or the clamping device 46 and the second mold half 42b. The film element 2 is deformed by the application of a pressure gradient between the front side and the rear side of the heated and clamped film element 2. The front side of the film element 2 points towards the second mold half 42b and the rear side of the film element 2 points towards the first mold half 42a.

The film element 2 is further preferably deformed by the provision of a negative pressure or vacuum between the first mold half 42a and the film element 2 in such a way that the shape of the film element 2 follows the contour of the cavity 47 of the first mold half.

It has proved advantageous to also heat the film element 2 further during the deformation by means of the heating module 1.

FIG. 13 shows the device for producing a molded part shown in FIG. 12 except for the fact that the first mold half 42a and the second mold half 42b are closed. The film element 2 is here preferably enclosed by the mold halves 42a, 42b and has in particular a possible maximum strain at 110% to 150%, preferably at 110% to 125%.

It has proved advantageous if the clamping force between the mold halves 42a, 42b is between 250 kN and 10,000 kN, in particular between 500 kN and 5000 kN.

FIG. 14 shows the device for producing a molded part shown in FIG. 13 except for the fact that a material melt is injected into the cavity 47a remaining between the first and the second mold half 42a, 42b through an injection channel 43a which runs through the second mold half 42b. The injection device injects the material melt into the remaining cavity 47a over a period of from 0.5 s to 100 s, in particular from 0.5 s to 60 s, wherein the material melt is preferably pressed into the remaining cavity at a pressure of from 200 bar to 10,000 bar, in particular from 200 bar to 3000 bar.

The duration of hardening of the material melt in the remaining cavity 47a to produce a molded part is from 1 s to 300 s, in particular 1 s to 120 s.

FIG. 15 shows the device for producing a molded part 21 shown in FIG. 14 except for the fact that the first mold half 42a and the second mold half 42b are open. The clamping device 46 is closed, wherein the clamping device is preferably opened from 0 s to 5 s after the hardening of the material melt.

Further, the molded part 21 is released from the film element 2, wherein in particular at least one decorative layer is passed or transferred from the film element 2 onto the molded part 21, and the molded part 21 is removed from the device.

FIG. 16 shows the device for producing a molded part 21 shown in FIG. 8. The method steps shown in FIGS. 8 to 16 are preferably repeated cyclically, in order to produce further molded parts 21.

A further embodiment example of the method for producing a molded part comprises one or more of the method steps:
arranging the film element 2 between two mold halves 42c, 42d;
closing the mold halves 42c, 42d;
heating the film element 2 by means of the heating module 1, which is arranged in the lower and/or upper mold half 42c, 42d or the first and/or the second mold half;
deforming the film element 2 by applying a pressure gradient between the front and rear side or the first and the second side of the film element 2 to form the molded part 21, wherein the pressure gradient lies between 5 bar and 200 bar, in particular between 10 bar and 100 bar;
removing the molded part 21.

It is particularly preferred here if the pressure gradient is chosen as follows: vacuum between −0.5 bar and −1 bar and/or excess pressure between +5 bar and +200 bar.

A further embodiment example of the method for producing a molded part comprises one or more of the method steps:
inserting the film element 2 into a carriage;
transporting the film element 2 by means of the carriage to the heating module 1;
heating the film element 2 by one or more heating modules 1 arranged in a series;
transporting the film element 2 by means of the carriage to a molding station 4;
deforming the film element 2 in the molding station 4 to form the molded part 21;
removing the molded part 21.

A further embodiment example of the method for producing a molded part comprises one or more of the method steps:
inserting the film element 2;
moving the heating module 1 in such a way that it is arranged above or at a distance of 0 mm and 150 mm, in particular between 0 mm and 75 mm, from the film element 2;
heating the film element 2 by the heating module 1;
deforming the film element 2 by applying a pressure gradient between the front and rear side 2c, 2d of the film element 2 to form the molded part 21, wherein the pressure gradient lies between 5 bar and 200 bar, in particular between 10 bar and 100 bar;
removing the molded part 21.

A further embodiment example of the method for producing a molded part comprises one or more of the method steps:
arranging the film element 2 between a flat first mold half 42a, or one having a cavity 47 and/or a male mold 48, and a flat second mold half 42b, or one having a cavity 47 and/or a male mold 48;
moving the heating module 1 in between the film element 2 and the second mold half 42b, and heating the film element 2 by the heating module 1;
optionally clamping the film element 2 onto the first mold half 42a by means of a clamping device 46;
optionally deforming the film element 2 following the contour of the cavity 47 and/or of the male mold 48 by the provision of a negative pressure or vacuum between the first mold half 42a and the film element 2, wherein the negative pressure or the vacuum lies between −0.1 bar and −1 bar, in particular between −0.5 bar and −1 bar;
moving the heating module 1 out;
closing the first mold half 42a and the second mold half 42b;
injecting a material melt through at least one injection channel 43 in the first mold half 42a and/or the second mold half 42b, whereby the molded part 21 is formed;
opening the first mold half 42a and second mold half 42b;
optionally opening the clamping device 46;
removing the molded part 21.

A further embodiment example of the method for producing a molded part comprises one or more of the method steps:
providing the cavity 47a between the film element 2 and the first and/or second mold half 42a, 42b by closing the first mold half 42a and the second mold half 42b.

### LIST OF REFERENCE NUMBERS

1 heating module
1a, 11a, 11 b, 11c, 11g, 11h, 11i heating segment
1b heating element
1c first direction of movement
1d second direction of movement
2 film element
2a first area
2b second area
2c front side
2d rear side
21 molded part
3 sensor
3a pyrometer
3b thermal imaging camera
4 molding station
41 mold
42 mold half
42a, 42c first mold half
42b, 42d second mold half
43 injection device
43a injection channel
44 transport device
45 carriage
46 clamping device
47 cavity
47a remaining cavity
48 male die
L axis
α, β angle
E reference surface

1. A heating module for heating at least one film element wherein,
the heating module has two or more heating segments with in each case one or more heating elements for heating a first area of the film element assigned to the respective heating segment, wherein the heating module and/or at least one of the heating segments comprises at least one sensor for measuring the state of the heating of the film element.

2. The heating module according to claim 1, wherein
the sensor or at least one of the sensors detects the state of the heating of the film element contactlessly in one or more assigned second areas of the film element.

3. The heating module according to claim 1, wherein
the sensor or at least one of the sensors is a pyrometer which detects the state of the heating of the film element contactlessly in an assigned second area of the film element.

4. The heating module according to claim 1, wherein
the sensor or at least one of the sensors detects the state of the heating of the film element in an assigned second area of the film element.

5. The heating module according to claim 1, wherein
the sensor or at least one of the sensors is a thermal imaging camera which detects the state of the heating of the film element in a plurality of second areas of the film element contactlessly.

6. The heating module according to claim 1, wherein
one or more of the heating segments comprise in each case the sensor or at least one of the sensors and wherein the second area or at least one of the second areas of the film element, in which the sensor or sensors detect the state of the heating of the film element, at least partially overlap the first area of the film element assigned to the respective heating segment.

7. The heating module according to claim 1, wherein
the second area or at least one of the second areas of the film element, in which the sensor or sensors detect the state of the heating of the film element, is or are arranged within the first area of the film element assigned to the respective heating segment.

8. The heating module according to claim 1, wherein
the sensor or one of the sensors detects the state of the heating of the film element in two or more second areas of the film element and wherein the second areas in each case at least partially overlap one of the first areas.

9. The heating module according to claim 1, wherein
at least two of the two or more heating segments are arranged movable relative to each other in the heating module.

10. The heating module according to claim 1, wherein
the heating module has an adjusting device by means of which the relative positional arrangement of two or more of the heating segments to each other can be altered.

11. The heating module according to claim 1, wherein
one or more of the heating segments in the heating module are mounted displaceable in the vertical or horizontal direction and/or one or more of the heating segments in the heating module are mounted tiltable, and wherein the horizontal or vertical position and/or the tilt angle can be adjusted by means of the adjusting device.

12. The heating module according to claim 1, wherein
the adjusting device has one or more electric servomotors and/or one or more pneumatic and/or hydraulic actuators by means of which the relative positional arrangement of two or more of the heating segments to each other can be altered.

13. (canceled)

14. (canceled)

15. (canceled)

16. (canceled)

17. A device for producing a molded part wherein,
the device has a heating module according to claim 1 and a mold for deforming the at least one film element heated by the heating module, to form the molded part.

18. The device according to claim 17, wherein
the mold has two mold halves, between which the film element can be arranged, wherein the heating module is arranged in the lower and/or upper mold half in such a way that the film element can be heated by means of the heating module after closing the mold halves and wherein the mold has means for applying a pressure gradient between the front and rear side of the film element in such a way that the film element is deformed to form the molded part by the pressure gradient between the front and rear side of the film element.

19. The device according to claim 17, wherein,
the device has a molding station which comprises the mold and wherein the device has a carriage for receiving the film element and wherein the device has a transport device for transporting the film element by means of the carriage to the heating module and to the molding station.

20. The device according to claim 17, wherein
the mold has a first mold half, wherein the film element can be arranged between the first mold half and the second mold half and wherein the heating module is mounted movable in such a way that the heating module can be moved in between the film element and the second mold half and moved out before closing the mold halves, and wherein the first and/or the second mold half has at least one injection channel for injecting a material melt.

21. A method for producing a molded part wherein,
a film element is heated by means of a heating module which has two or more heating segments with in each case one or more heating elements for heating a first area of the film element assigned to the respective heating segment, wherein the heating module and/or at least one of the heating segments comprises at least one sensor for measuring the state of the heating of the film element and wherein the film element is deformed to form the molded part.

22. The method according to claim 21, wherein
the heat output of the two or more heating segments is set or adjusted in each case individually.

23. The method according to claim 21, wherein
the heat output of at least one of the heating segments is set or adjusted on the basis of the state of the heating of the film element detected by the at least one sensor.

24. The method according to claim 21, wherein
the heat output of at least one of the heating segments is set or adjusted on the basis of the state of the heating of the film element detected by the at least one sensor as well as a predefined target temperature profile of the film element determined by the contour design of the molded part.

25. The method according to claim 21, wherein
the heat output of at least one of the heating segments is set or adjusted on the basis of the state of the heating of the film element detected by the at least one sensor as well as data on the contour of the molded part.

26. The method according to claim 21, wherein
the positioning of the heating segments is set or is adjusted on the basis of data on the contour of the molded part.

27. The method according to claim 21, wherein
the data on the contour of the film element comprise one or more of the following data: presence and position of curvatures of the contour, radius of curvature, direction of curvature, spacing from a reference surface, vertical or horizontal spacing of an area of surface of the contour from one or more of the heating segments position of recesses and/or through-holes of the molded part.

28. The method according to claim 21, wherein
the heat output of at least one of the heating segments is set or adjusted on the basis of the state of the heating of the film element detected by the at least one sensor in the first area of the film element assigned to the heating segment.

29. The method according to claim 21, wherein
the heat output of at least one of the heating segments is set or adjusted on the basis of the state of the heating of the film element detected by the at least one sensor in the first area of the film element assigned to another of the heating segments.

30. The method according to claim 21, wherein
the sensor or at least one of the sensors detects the state of the heating of the film element contactlessly in one or more assigned second areas of the film element.

31. The method according to claim 21, wherein
the second area or at least one of the second areas of the film element, in which the sensor or sensors detect the state of the heating of the film element, at least partially overlaps one of the first areas of the film element.

32. The method according to claim 21, wherein
the relative positional arrangement of two or more of the heating segments to each other is set or adjusted by means of an adjusting device of the heating module.

33. The method according to claim 21, wherein
the horizontal or vertical position of one or more of the heating segments which are mounted displaceable in the vertical or horizontal direction in the heating module is set or adjusted by means of the adjusting device, and/or the tilt angle of one or more of the heating segments which are mounted tiltable in the heating module is set or adjusted by means of the adjusting device.

34. The method according to claim 21, wherein
the method comprises the steps:
arranging the film element between two mold halves;
closing the mold halves;
heating the film element by means of the heating module, which is arranged in the lower and/or upper mold half;
deforming the film element by applying a pressure gradient between the front and rear side of the film element to form the molded part;
removing the molded part.

35. (canceled)

36. (canceled)

37. (canceled)

38. (canceled)
